(19) United States
(12) Patent Application Publication
(10) Pub. No.: US 2006/0192997 A1
(43) Pub. Date: Aug. 31, 2006

(54) Print status monitor control for printing devices on network

(75) Inventors: Akira Matsumoto, Nagano-ken (JP); Toshihiro Shima, Nagano-ken (JP)

Correspondence Address: SUGHRUE MION, PLLC, 2100 PENNSYLVANIA AVENUE, N.W., SUITE 800, WASHINGTON, DC, 20037, US

(73) Assignee: SEIKO EPSON CORPORATION

(21) Appl. No.: 11/355,071

(22) Filed: Feb. 16, 2006

(30) Foreign Application Priority Data
Feb. 17, 2005 (JP) 2005-40051

(51) Int. Cl. G06F 3/12

(52) U.S. Cl. 358/1.15

(57) ABSTRACT

In a print status monitor system of the invention, a specified printer receives a polling interval reduction request from a server in response to polling made at a normal polling interval set to a polling interval, and changes the polling interval to a shorter polling interval, which is shorter than the normal polling interval. The server sends a print status transmission request to the specified printer, in response to polling made by the specified printer at the shorter polling interval. The specified printer receives the print status transmission request sent from the server in response to the polling made to the server at the shorter polling interval, obtains print status information representing the status of a print job, and sends the obtained print status information to the server. The server receives and obtains the print status information sent from the specified printer in response to the print status transmission request. This arrangement enables the server to monitor the status of a print job sent to a printer under management of the server, while reducing the potential for heavy network traffic.

### BACKGROUND OF THE INVENTION

1. Field of the Invention

The present invention relates to a technique of monitoring the status of printing in printers on a network.

2. Description of the Related Art

With the recent advance of the network technology relating to the Internet and local area networks, device management systems have been proposed, in which multiple devices, such as printers, on a network are managed by a management server connected to the multiple devices via the network (see, for example, Japanese Patent Laid-Open Gazette No. 2004-185351 and No. 2002-189638). In the proposed device management system, each device connected to the network has a built-in network board to obtain predetermined monitor information regarding the device, for example, the operation state of the device, and sends the obtained monitor information to the management server. The monitor information obtained by monitoring a printer as the device includes, for example, the number of prints, the consumed quantities of inks or toners, the remaining quantities of inks or toners, and error information.

In the device management system, a firewall may be provided between the management server and the device. This structure may interfere with the management server-based operations to send a transmission request of the monitor information to the device and obtain the monitor information from the device in response to the transmission request. In one adoptable structure proposed as the countermeasure against such interference, the device takes a leading role and sends collected monitor information to the management server at regular intervals.

This proposed structure, however, still has a problem.

A print job file (print command file) is sent from the management server as a print request source over a firewall to a selected printer as a printing destination printer, which then executes a print job specified by the print job file. In this case, one preferable arrangement enables the management server as the print request source to monitor the status of the print job (print status) executed by the printing destination printer.

In the device management system with the firewall, the management server is not allowed to voluntarily send the transmission request of the monitor information to the printing destination printer as described above. The printing destination printer thus takes a leading role and sends information on the print status (print status information) as the monitor information to the management server at regular intervals. The management server as the print request source monitors the print status, based on the print status information or the monitor information regularly sent to the management server.

The conventional monitor information sent to the management server does not reflect the momentarily changing print status but regards, for example, the number of prints, the consumed quantities of inks or toners, or the remaining quantities of inks or toners. Heavy network traffic may be caused by concentrated transmission of the monitor information from many devices managed by the management server. The interval of the regular transmission of the monitor information to the management server is set to avoid such heavy network traffic. The interval of the regular transmission of the monitor information is thus significantly greater than the change rate of the momentarily changing print status. The simple regular transmission of the monitor information from the printing destination printer to the management server thus does not enable the management server to effectively monitor the momentarily changing print status.

### SUMMARY OF THE INVENTION

The object of the invention is thus to eliminate the drawbacks of the prior art technique and to provide a technique adopted in a device management system where predetermined monitor information is sent from a device to a management server. The technique enables the management server to monitor the status of a print job sent from the management server to a printer as a device managed by the management server, while reducing the potential for heavy network traffic.

In order to attain at least part of the above and the other related objects, the present invention is directed to a print status monitor control apparatus that is built in at least one specified printer among multiple printers on a certain network to monitor status of a print job sent from a server, which is connected to the certain network via a firewall, and to send a monitoring result to the server. The print status monitor control apparatus includes: a server access control module that makes polling to the server at a preset polling interval and establishes communication with the server; and a print status monitor control module that monitors the status of the print job. In response to reception of a polling interval reduction request from the sever, the server access control module changes the polling interval to a shorter polling interval, which is shorter than a preset normal polling interval. When the server access control module makes polling to the server at the shorter polling interval and receives a print status transmission request from the server, the print status monitor control module obtains print status information representing the status of the print job and controls the server access control module to send the obtained print status information to the server.

The print status monitor control apparatus of the invention is built in, for example, as a network card or a network board, in a printer on a network.

A print job is sent from the server to the specified printer to be executed. The specified printer receives the polling interval reduction request in response to the polling made to the server at the normal polling interval, changes the polling interval to the shorter polling interval, which is shorter than the normal polling interval, and makes subsequent polling at the shorter polling interval. The specified printer receives the print status transmission request sent from the server in response to the polling to the server at the shorter polling interval, obtains the print status information representing the status of the print job, and sends the obtained print status information to the server. Namely the server sends the print status transmission request to the specified printer at the shorter polling interval and obtains the print status information representing the status of the print job. This arrangement enables the server to effectively monitor the momentarily changing status of the print job.

The polling interval of the specified printer is set in advance to the normal polling interval and is changed to the shorter polling interval in response to the polling interval reduction request sent from the server. The server then sends the print status transmission request to the specified printer at the shorter polling interval. The server sends the polling interval reduction request to the specified printer only in the state of monitoring the status of the print job sent from the server. In this state, the specified printer accordingly makes polling to the server at the shorter polling interval. In the state of no monitoring the print status, on the other hand, the specified printer makes polling to the server at the normal polling interval. Setting a sufficiently long time to the normal polling interval desirably reduces the potential for heavy network traffic.

In one preferable embodiment of the invention, the print status monitor control apparatus further has a distributed printing control module that distributes the print job to at least one distribution destination printer specified among the multiple printers. In the case of distribution of the print job to the specified distribution destination printer, the print status monitor control module obtains information representing a status of each division of the distributed print job from the specified distribution destination printer, as the print status information.

When a print job sent from the server to the specified printer is distributed by the specified printer to one or multiple distribution destination printers for distributed printing, the server may not be informed of identification of the distribution destination printers specified for distributed printing of the print job. The arrangement of this preferable embodiment advantageously enables the specified printer to obtain the information representing the status of each division of the distributed print job from each distribution destination printer and to send the obtained information as the print status information to the server.

In the print status monitor control apparatus of the invention, the print status monitor control module preferably sends only a piece of information having any change between polling timings of the shorter polling interval to the server as the print status information.

This arrangement minimizes the information volume sent to the server as the print status information and thus effectively reduces the network traffic.

The technique of the invention is also applicable to a printer. Namely the invention is directed to a printer that is connected to a certain network and includes the print status monitor control apparatus having any of the arrangements described above.

The printer of the invention sends the print status information representing the status of a print job, which is sent from the server to the printer, in response to the print status transmission request sent from the server to the printer at the shorter polling interval. This arrangement enables the server to monitor the momentarily changing status of the print job, while reducing the potential for heavy network traffic.

The present invention is also directed to a server that is connected to a certain network via a firewall and receives print status information representing status of a print job, which is sent to at least one specified printer among multiple printers on the certain network. The server includes: a device access control module that establishes communication with the specified printer, in response to polling made by the specified printer at a preset polling interval; and a print job monitor module that causes the specified printer to monitor the status of the print job. The print job monitor module controls the device access control module to send a polling interval reduction request to the specified printer, in response to polling made by the specified printer at a normal polling interval set to the polling interval, and causes the specified printer to change the polling interval of the specified printer to a shorter polling interval, which is shorter than the normal polling interval. The print job monitor module controls the device access control module to send a print status transmission request to the specified printer, in response to polling made by the specified printer at the shorter polling interval, and controls the device access control module to receive and obtain the print status information sent back from the specified printer in response to the print status transmission request.

The server of the invention sends the polling interval reduction request to the specified printer in response to the polling made by the specified printer at the normal polling interval, and causes the specified printer to change the polling interval of the specified printer to the shorter polling interval. The server sends the print status transmission request to the specified printer in response to the polling made by the specified printer at the shorter polling interval, and receives and obtains the print status information sent from the specified printer in response to the print status transmission request. The server of this arrangement receives and obtains the print status information from the specified printer at the shorter polling interval and thus effectively monitors the momentarily changing status of the print job.

The server of the invention sends the polling interval reduction request to the specified printer only in the state of monitoring the status of the print job sent from the server. In this state, the specified printer accordingly makes polling to the server at the shorter polling interval. In the state of no monitoring the print status, on the other hand, the specified printer makes polling to the server at the normal polling interval. Setting a sufficiently long time to the normal polling interval desirably reduces the potential for heavy network traffic.

The present invention is further directed to a print status monitor system where a server connected to a certain network via a firewall monitors status of a print job, which is sent from the server to at least one specified printer among multiple printers on the certain network. The server sends a polling interval reduction request to the specified printer, in response to polling made by the specified printer at a normal polling interval set to a polling interval. The specified printer changes the polling interval to a shorter polling interval, which is shorter than the normal polling interval, in response to reception of the polling interval reduction request from the server and makes polling to the server at the shorter polling interval. The server sends a print status transmission request to the specified printer in response to the polling made by the specified printer at the shorter polling interval. The specified printer receives the print status transmission request sent from the server in response to the polling made to the server at the shorter polling interval, obtains print status information representing the status of the print job, and sends the obtained print status information to the server. The server receives and acquires the print status information sent from the specified printer in response to the print status transmission request.

In the print status monitor system of the invention, the server receives and obtains the print status information from the specified printer at the shorter polling interval. The server can thus effectively monitor the momentarily changing status of the print job.

The server sends the polling interval reduction request to the specified printer only in the state of monitoring the status of the print job sent from the server. In this state, the specified printer accordingly makes polling to the server at the shorter polling interval. In the state of no monitoring the print status, on the other hand, the specified printer makes polling to the server at the normal polling interval. Setting a sufficiently long time to the normal polling interval desirably reduces the potential for heavy network traffic.

Any of the above applications of the invention may not have all the stated characteristic functions but may have some omission or appropriate combination of such characteristic functions. The technique of the invention is not restricted to the print status monitor control apparatus, the printer, the server, or the print status monitor system but may also be actualized by corresponding control methods of the print monitor status control apparatus, the printer, the server, and the print status monitor system. There are other diverse applications of the invention, for example, computer programs to actualize these control methods, recording media in which such computer programs are recorded, and data signals that include such computer programs and are embodied in carrier waves. Any of the preferable arrangements described above may be added to any of these diverse applications.

In the applications of the invention as the computer programs and the recording media in which the computer programs are recorded, the invention may be given as a whole program to control the operations of the device monitor apparatus or the operations of the device or as a partial program to perform only the characteristic functions of the invention. Available examples of the recording medium include flexible disks, CD-ROMs, DVD-ROMs, magneto-optical disks, IC cards, ROM cartridges, punched cards, prints with barcodes or other codes printed thereon, internal storage devices (memories like RAMs and ROMs) and external storage devices of the computer, and diversity of other computer readable media.

### BRIEF DESCRIPTION OF THE DRAWINGS

FIG. 1 schematically illustrates the configuration of a device management system in one embodiment of the invention;

FIG. 2 schematically shows the structure of a printer PRT1 included in the device management system of the embodiment;

FIG. 3 schematically shows the structure of a management server SV included in the device management system of the embodiment;

FIG. 4 is a flowchart showing a print status monitor process executed by the printer PRT1 specified as a printing destination printer;

FIGS. 5(A) and 5(B) show print status information stored in a print status storage field in the printer PRT1;

FIG. 6 shows a print status monitor MIB stored in an MIB storage field in the printer PRT1 as the printing destination printer and an MIB stored in a memory of a printer main body of a specified distribution destination printer;

FIG. 7 is a flowchart showing a print status monitor process executed by the management server SV;

FIG. 8 shows a print status display window W1 displayed by a monitoring result presentation module of the management server SV; and

FIG. 9 shows a detailed print status display window W2 displayed by the monitoring result presentation module.

### DESCRIPTION OF THE PREFERRED EMBODIMENTS

One mode of carrying out the invention is described below as a preferred embodiment in the following sequence:

A. Embodiment

A1. Configuration of Device Management System
A2. Structure of Printer
A3. Structure of Management Server
A4. Monitoring Print Status
   A4.1. Monitoring Print Status in Printing Destination Printer
   A4.2. Monitoring Print Status in Management Server
   A4.3. Display of Print Status
A5. Effects of Embodiment
   B. Modifications
   A. Embodiment
   A1. Configuration of Device Management System

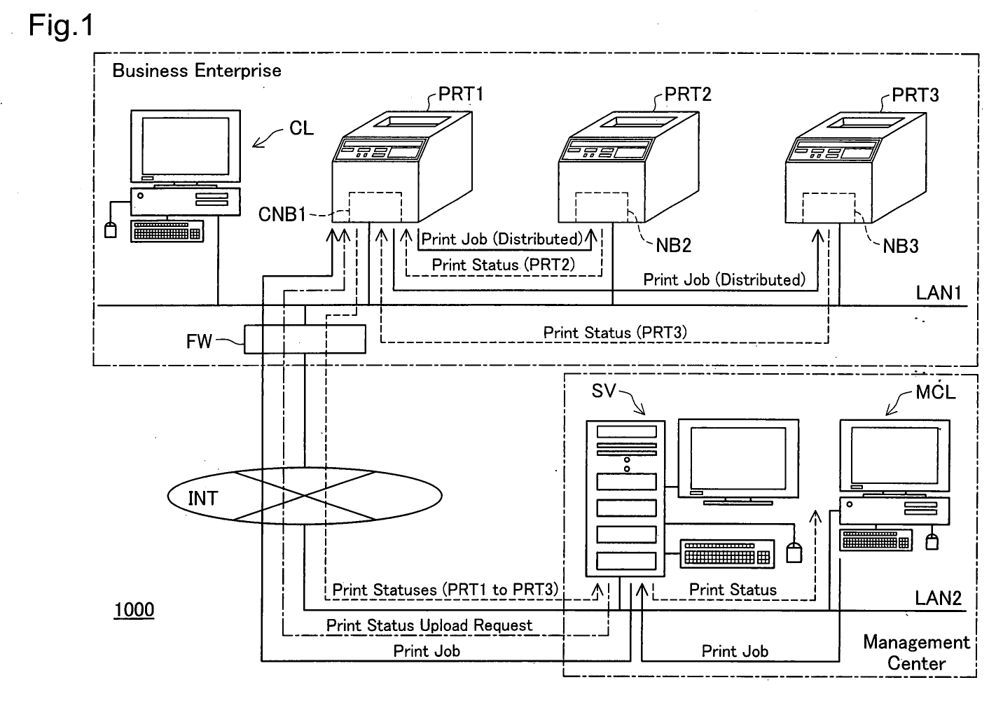

FIG. 1 schematically illustrates the configuration of a device management system 1000 in one embodiment of the invention. In the device management system 1000 of the embodiment, a local area network LAN1 constructed in an organization, for example, a business enterprise (hereafter referred to as in-company local area network LAN1), is connected to a local area network LAN2 constructed in a management center (hereafter referred to as in-management center local area network LAN2) via the Internet INT. A management server SV linked to the in-management center local area network LAN2 is accordingly connected with the in-company local area network LAN1.

A firewall FW is placed between the in-company local area network LAN1 and the Internet INT to prohibit external accesses from the Internet INT to the in-company local area network LAN1.

In the illustrated example of FIG. 1, only one in-company local area network LAN1 is connected to the management server SV. This is, however, only illustrative and the number of the in-company local area networks LAN1 connected to the management server SV may be set arbitrarily.

In addition to the management server SV, a client computer MCL (hereafter simply referred to as ‘client’) operated by an operator, for example, a system manager, is connected to the in-management center local area network LAN2. In the illustrated example of FIG. 1, only one client MCL is connected to the in-management center local area network LAN2. This is, however, only illustrative and the number of clients MCL connected to the in-management center local area network LAN2 may be set arbitrarily. The number of any devices, for example, servers and printers, connectable to the network may also be set arbitrarily.

Multiple clients CL and multiple printers PRT are connectable to the in-company local area network LAN1. In the illustrated example of FIG. 1, three printers PRT1 to PRT3 and one client CL1 are connected to the in-company local area network LAN1. This is, however, only illustrative and the numbers of the clients CL and the printers PRT connected to the in-company local area network LAN1 may be set arbitrarily.

Communication established between the respective devices on the network is based on the TCP/IP protocol, and an IP address is allocated to each device. Communication data sent from a sender device includes an IP address of the sender device (sender IP address) and an IP address of a receiver device (receiver IP address). The communication data is sent to the receiver device identified by the receiver IP address.

Among the multiple printers PRT, the printer PRT1 has a built-in custom network board CNB1, which has server access control functions and device monitor control functions as well as general communication control functions.

The server access control functions of the custom network board CNB1 enable the printer PRT1 to make polling to the management server SV at a preset polling interval and to receive and send communication data from and to the management server SV (download and upload).

The device monitor control functions of the custom network board CNB1 built in the printer PRT1 monitor the operations of the multiple printers PRT including the printer PRT1. The custom network board CNB1 gives instructions to these printers PRT and receives and obtains monitor information regarding the operations of the printers PRT via the general communication control functions of the respective printers PRT. The server access control functions of the custom network board CNB1 in combination with the general communication control functions send the obtained monitor information of the respective printers PRT to the management server SV (upload).

Each of the printers PRT other than the printer PRT1 has a standard built-in network board (not shown), which has the general communication control functions to receive and send communication data from and to the respective devices on the network.

The management server SV also has a standard built-in network board (not shown), which has the general communication control functions to receive and send communication data from and to the respective devices on the network.

The management server SV has device access control functions to receive and send communication data from and to the printer PRT1 having the server access control functions. The management server SV receives the monitor information sent from the printer PRT1 and stores the received monitor information into a database (not shown), while sending diversity of communication data to the printer PRT1.

In the device management system 1000 of the embodiment, the printer PRT1, which is placed in the business enterprise and is accessible to the management server SV (hereafter may be referred to as the ‘mother printer’), sends the own monitor information and the monitor information of the other printers PRT2 and PRT3, which are inaccessible to the management server SV (hereafter may be referred to as ‘child printers’), to the management server SV placed in the management center at every polling timing corresponding to the polling interval set in the printer PRT1. The management server SV stores and manages the received monitor information.

The built-in custom network board CNB1 of the printer PRT1 additionally has distributed printing control functions to send received communication data including print job data to one or multiple printers specified as distribution destinations (hereafter may be referred to as distribution destination printers) for distributed printing.

The custom network board CNB1 of the printer PRT1 further has print status monitor control functions. The management server SV has print job monitor functions, in addition to the device access functions. The combination of the print status monitor control functions and the print job monitor functions is characteristic of the invention and monitors the status of each print job (print status) performed according to a print job file sent (downloaded) from the management server SV as a print request sender to the printer PRT1.

The process of monitoring the print status is described briefly, on the assumption that a print job performed according to a print job file sent from the management server SV to the printer PRT1 is set not for ordinary printing but for distributed printing and that the three printers PRT1 to PRT3 are specified as the distribution destination printers.

The print job file is sent (uploaded) by the client MCL to the management server SV and is then transmitted (downloaded) from the management server SV as a print request sender to the printer PRT1 as a printing destination printer. The print job file is registered as a download file to the printer PRT1 by specifying the printer PRT1 as a receiver (download destination) of the print job file.

The print job file registered as the download file to the printer PRT1 is sent (downloaded) to the printer PRT1 at the polling timing when the printer PRT1 makes polling to the management server SV.

Since the downloaded print job file is set for distributed printing, the print job data is distributed to the printers PRT1 to PRT3 specified as the three distribution destination printers or printing execution printers. The printers PRT1 to PRT3 respectively perform allocations of the print job corresponding to the received divisions of the print job data.

The printer PRT1 as the printing destination printer receives print status upload request information as a request for sending (uploading) print status information from the management server SV at every polling timing corresponding to the preset polling interval when the printer PRT1 makes polling to the management server SV. The printer PRT1 having the print status monitor control functions obtains print status information from the respective distribution destination printers (printing execution printers) and sends back (uploads) the obtained print status information to the management server SV.

The management server SV having the print job monitor functions successively updates and stores the print status information sent back (uploaded) from the printer PRT1 as a response to the sent print status upload request information.

The operator executes a browser on the client MCL to browse the print status information successively updated and stored in the management server SV and check the latest print status. The operator may otherwise browse the print status information displayed on a monitor of the management server SV to check the print status.

In the illustration of FIG. 1, the flow of the print job, the flow of the print status upload request, and the flow of the print status information are shown by the arrows of solid line, the arrows of one-dot chain line, and the arrows of broken line, respectively. The details of these flows will be described later.

A2. Structure of Printer

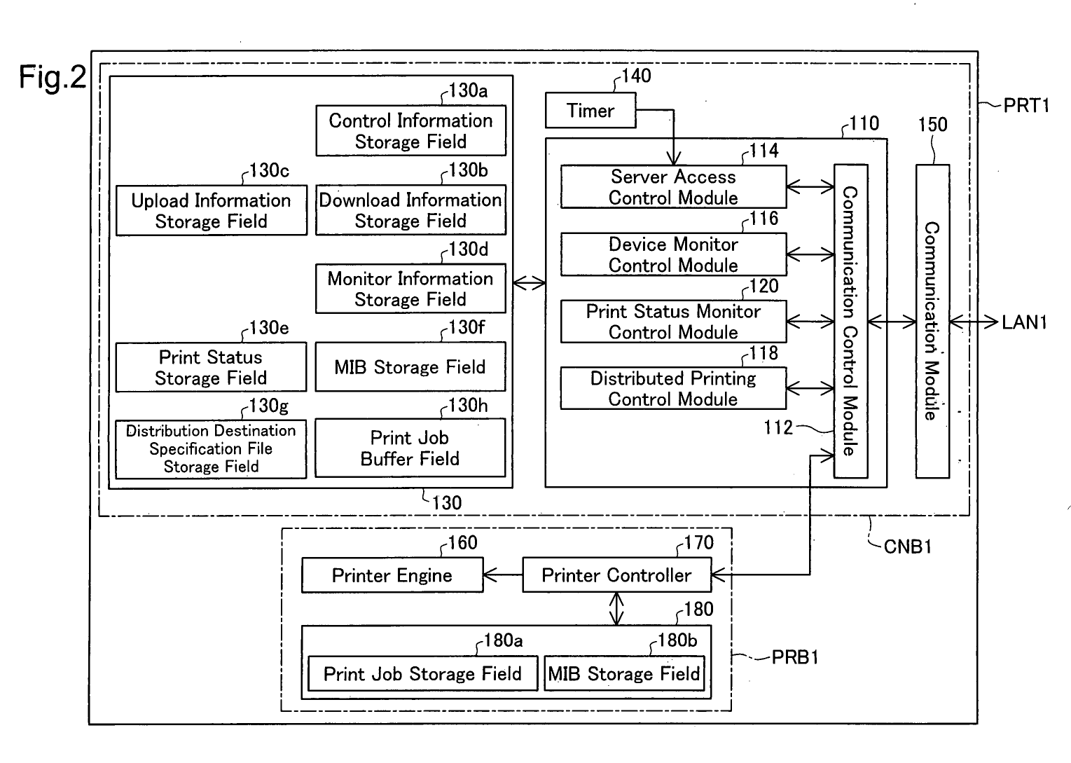

FIG. 2 schematically shows the structure of the printer PRT1. The printer PRT1 as the mother printer in the device management system 1000 of FIG. 1 includes a printer main body PRB1 that performs actual printing and the custom network board CNB1. The printer main body PRB1 mainly has a printer engine 160, a printer controller 170, and a memory 180.

The printer engine 160 is a printing mechanism, and the printer controller 170 is a computer including a CPU, a RAM, and a ROM (not shown). The printer controller 170 receives print job data from the custom network board CNB1 and stores the received print job data into a print job storage field 180a set in the memory 180. The print controller 170 reads the print job data from the print job storage field 180a and controls the printer engine 160 to implement printing according to the print job data. The printer controller 170 also detects information regarding the number of prints, the consumed quantities of inks or toners, the remaining quantities of inks or toners, or the status of each print job (print status), for example, the number of copies and the current status (for example, in-printing, end-of-printing, paper jam), and stores the detected information in the form of an MIB (management information base) into an MIB storage field 180b set in the memory 180. The MIB includes information specified as unified standard of the printer main body PRB1 and information individually specified by the manufacturer.

The custom network board CNB1 includes a CPU 110, a memory 130, a timer 140, and a communication module 150. The CPU 110 has functional blocks of a communication control module 112, a server access control module 114, a device monitor control module 116, a distributed printing control module 118, and a print status monitor control module 120. The CPU 110 reads and executes a preset computer program stored in a ROM (not shown) to implement these functional blocks as the software configuration. Part or all of these functional blocks may otherwise be constructed by the hardware configuration.

The communication control module 112 selectively activates an appropriate communication protocol corresponding to each communication object, for example, the client CL1, another printer PRT, or the management server SV, and controls the communication module 150 to make communication with the communication object via the local area network LAN1 and the Internet INT. According to a concrete procedure, the communication control module 112 extracts a sender IP address and a sender port number included in received communication data, while adding a sender IP address and a sender port number to communication data to be sent. The communication control module 112 transmits data to and from the printer controller 170.

The server access control module 114 makes polling to the management server SV via the communication control module 112 at every polling timing, which corresponds to a preset polling interval and is generated by the timer 140, to be accessible to the management server SV. The server access control module 114 receives a download file, which is to be downloaded to the printer PRT1, or request information, if any, from the management server SV, and stores the received download file or the received request information into a download information storage field 130b set in the memory 130. The server access control module 114 analyzes the contents of the received download file or the received request information and adequately distributes the data included in the download file or the request information. In one example, when a print job file set for distributed printing is sent as the download file from the management server SV, the server access control module 114 transfers print job data of the received download file to the distributed printing control module 118. In another example, when a print status upload request is sent as the request information from the management server SV, the server access control module 114 transfers the request information to the print status monitor control module 120.

The server access control module 114 sends an upload file or request information, if any, stored in an upload information storage field 130c set in the memory 130, to the management server SV.

In response to a preset command on SNMP (Simple Network Management Protocol), the device monitor control module 116 reads and obtains various pieces of information regarding the operations of the printer PRT1 (hereafter may be referred to as ‘MIB information’) from the MIB stored in the MIB storage field 180b set in the memory 180 via the communication control module 112 and the printer controller 170. The device monitor control module 116 also reads and obtains MIB information from the MIBs stored in the respective child printers PRT. The device monitor control module 116 then collectively stores the obtained MIB information as device monitor information of monitor object printers into a monitor information storage field 130d set in the memory 130. The device monitor information stored in the monitor information storage field 130d is transferred to the server access control module 114 and is stored and registered in the upload information storage field 130c as an upload file in an uploadable form to the management server SV. The device monitor information is then sent (uploaded) as the upload file to the management server SV and is stored and managed by the management server SV.

The distributed printing control module 118 receives the print job data for distributed printing and stores the received print job data into a print job buffer field 130h set in the memory 130. The distributed printing control module 118 rewrites a QT value, which is included in the stored print job data and represents the number of required copies to be printed, and delivers respective divisions of the print job data with the rewritten QT values as distributed print job data to the respective printers PRT specified as the distribution destination printers via the communication control module 112.

A technique of varying a port number of a non-procedure protocol used as a printing protocol may be adopted to specify distributed printing. Another printing protocol with a variable port number may alternatively be used for this purpose; for example, LPR (Line Printer Daemon Protocol), IPP (Internet Printing Protocol), FTP (File Transfer Protocol), SMB (Server Message Block), or AppleTalk. Any of various combinations of these printing protocols, for example, a combination of the LPR and the non-procedure protocol, may be used to specify distributed printing. A flag for discriminating distributed printing from ordinary printing may be provided for specification of distributed printing.

The distributed printing control module 118 sends a preset command on the SNMP to respective candidate printers stored as possible options in a distribution destination specification file storage field 130g set in the memory 130 to inquire for printability. The distributed printing control module 118 receives responses to the inquiry from the respective candidate printers and specifies some or all of the printers in a printable state as distribution destination printers. The distribution destination printers may include or may not include the mother printer PRT1.

The print status monitor control module 120, in response to a print status upload request from the management server SV, monitors the status of a print job (print status) performed according to a print job file sent (downloaded) from the management server SV and sends back the result of monitoring to the management server SV via the server access control module 114. According to a concrete procedure, in response to a print status upload request from the management server SV, the print status monitor control module 120 sends a preset command on the SNMP to each printing execution printer, which performs a print job, reads and obtains information representing the print status from the MIB stored in the printing execution printer, and stores the obtained information as a print status monitor MIB into an MIB storage field 130f set in the memory 130. The print status monitor control module 120 obtains the information representing the print status (print status information) from the print status monitor MIB stored in the MIB storage field 130f and stores the obtained print status information into a print status storage field 130e set in the memory 130. The print status monitor control module 120 sends back (uploads) the obtained print status information to the management server SV via the server access control module 114 as a response to the print status upload request from the management server SV.

The timer 140 counts the time since power-on of the printer PRT1. The timer 140 generates a polling timing corresponding to a preset polling interval Tp read from a control information storage field 130a set in the memory 130 and outputs the generated polling timing to the server access control module 114.

The memory 130 includes the control information storage field 130a, the download information storage field 130b, the upload information storage field 130c, the monitor information storage field 130d, the print status storage field 130e, the MIB storage field 130f, the distribution destination specification file storage field 130g, and the print job buffer field 130h. The control information storage field 130a stores diverse pieces of control information regarding the operations of the respective functional blocks of the communication control module 112, the server access control module 114, the device monitor control module 116, the distributed printing control module 118, and the print status monitor control module 120. The download information storage field 130b stores the download files and request information downloaded from the management server SV. The upload information storage field 130c stores the upload files and request information to be uploaded to the management server SV. The monitor information storage field 130d stores the device monitor information obtained from the monitor object printers by the device monitor control module 116. The print status storage field 130e stores the print status information obtained by the print status monitor control module 120. The MIB storage field 130f stores the print status monitor MIB obtained by the print status monitor control module 120. The distribution destination specification file storage field 130g stores a list of candidate printers available as distribution destination printers. The print job buffer field 130h temporarily stores the print job data received by the distributed printing control module 118.

Each of the child printers, for example, the printers PRT2 and PRT3 shown in FIG. 1, has substantially identical structure and functions as those of the printer main body PRB1 of the mother printer PRT1. Namely each of the child printers includes a printer engine, a printer controller, a memory, and a network board as a standard network interface (network I/F) to execute the general communication control functions. In the illustrated example of FIG. 1, the child printers PRT2 and PRT3 respectively have network boards NB2 and NB3.

A3. Structure of Management Server

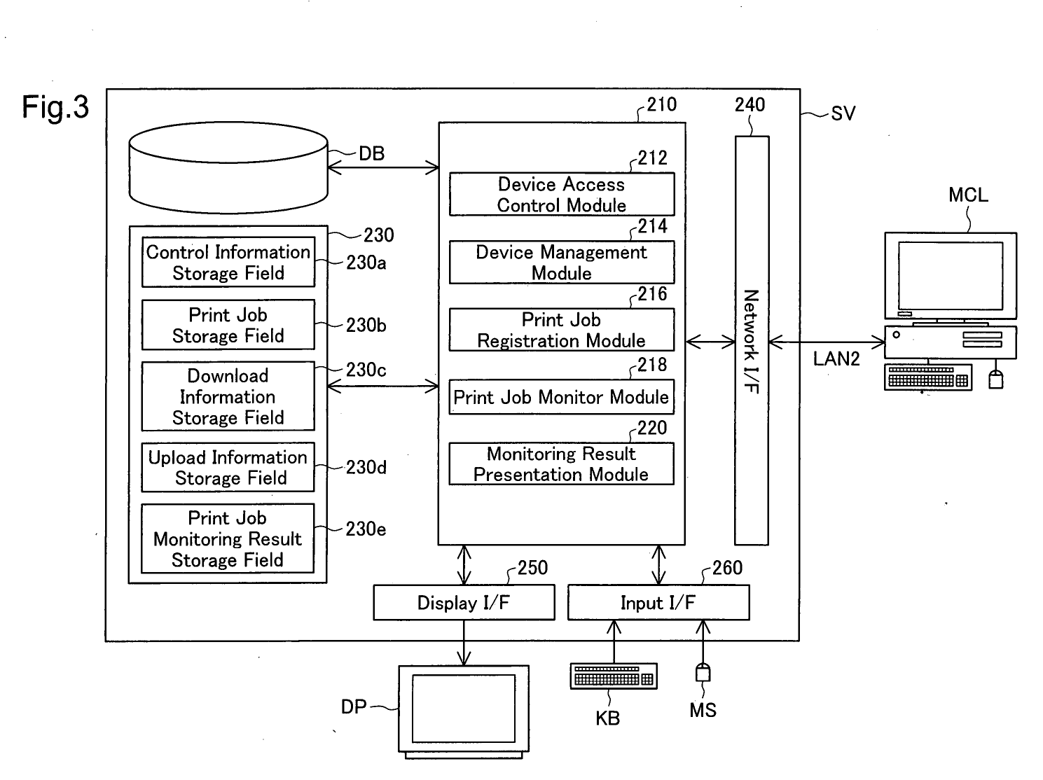

FIG. 3 schematically shows the structure of the management server SV. The management server SV is constructed as a computer system having a CPU 210, a memory 230 including a RAM and a ROM, a network I/F (interface) 240, a display I/F 250, an input I/F 260, and a database DB.

The network I/F 240 has an interfacing function to make communication with the client MCL and with the printer PRT1 on the in-company local area network LAN1 via the local area network LAN2 and the Internet INT. The display I/F 250 has an interfacing function to display images on a monitor DP. The input I/F 260 has an interfacing function to receive data entries from a keyboard KB and a mouse MS.

The CPU 210 has functional blocks of a device access control module 212, a device management module 214, a print job registration module 216, a print job monitor module 218, and a monitoring result presentation module 220. The CPU 210 reads and executes a preset computer program stored in the memory 230 to implement these functional blocks as the software configuration. Part or all of these functional blocks may otherwise be constructed by the hardware configuration.

The device access control module 212 responds to polling from the mother printer PRT accessible to the management server SV, for example, the printer PRT1 (see FIG. 2), and enables access from the mother printer PRT. The device access control module 212 sends a download file, which is to be sent to the mother printer PRT, or request information, if any, stored in a download information storage field 230c set in the memory 230 to the printer PRT, while receiving an upload file sent from the printer PRT. The device access control module 212 stores the received upload file into an upload information storage field 230d set in the memory 230, analyzes the received upload file, and adequately distributes the data included in the analyzed upload file. For example, the device monitor information uploaded at a normal polling interval Tpn (described later) is transferred to the device management module 214. The print status information uploaded at a shorter polling interval Tps (described later) is transferred to the print job monitor module 218.

The print job registration module 216 receives a print job file sent (uploaded) via the client MCL and stores the received print job file into a print job storage field 230b set in the memory 230. The print job file stored in the print job storage field 230b is transferred to the device access control module 212 and is stored and registered in the download information storage field 230c as a download file in a downloadable form to the mother printer PRT specified as a printing destination printer via the client MCL. The print job file stored as the download file in the download information storage field 230c is downloaded to the printer PRT specified as the printing destination printer in response to polling from the printer PRT. The printer PRT receives the downloaded print job file and implements printing according to print job data expressed by the print job file. In the illustrated example of FIG. 1, only the printer PRT1 is the mother printer specifiable as a printing destination printer.

The print job monitor module 218 sends print status upload request information as a request for uploading the print status information to the printer PRT specified as the printing destination printer via the device access control module 212. The print job monitor module 218 receives the print status information sent back in response to the print status upload request and updates the print status information stored in a print job monitoring result storage field 230e set in the memory 230. According to a concrete procedure, the print job monitor module 218 instructs the device access control module 212 to store and register the print status upload request information as download information into the download information storage field 230c. The registered print status upload request information is sent (downloaded) to the printer PRT specified as the printing destination printer in response to polling from the printer PRT to the management server SV. In response to the print status upload request, the print status information is sent back (uploaded) from the printer PRT specified as the printing destination printer to the management server SV. The uploaded print status information is transferred from the device access control module 212 to the print job monitor module 218. In this process, the print job monitor module 218 obtains the print status information sent back from the printer PRT specified as the printing destination printer.

The monitoring result presentation module 220 presents the status of each print job, which has been sent from the management server SV to the printer PRT as the printing destination printer to be executed, to a browser on the client MCL, based on the print status information stored in the print job monitoring result storage field 230e. The status of the print job is then displayed on a monitor of the client MCL. The monitoring result presentation module 220 may also display the status of the print job on the monitor DP connected with the management server SV.

The memory 230 includes a control information storage field 230a, the print job storage field 230b, the download information storage field 230c, the upload information storage field 230d, and the print job monitoring result storage field 230e. The control information storage field 230a stores diverse pieces of control information regarding the operations of the respective functional blocks of the device access control module 212, the device management module 214, the print job registration module 216, the print job monitor module 218, and the monitoring result presentation module 220. The print job storage field 230b stores the print job file obtained by the print job registration module 216. The download information storage field 230c stores the download files and request information to be downloaded from the management server SV. The upload information storage field 230d stores the upload files and request information uploaded to the management server SV. The print job monitoring result storage field 230e stores the print status information obtained by the print job monitor module 218.

A4. Monitoring Print Status

The procedure of monitoring the status of each print job (print status) executed according to a print job file sent from the management server SV to the printing destination printer PRT is described below in the sequence of a process of monitoring the print status in the printing destination printer PRT, a process of monitoring the print status in the management server SV, and a process of displaying the print status.

The following description is on the assumption that the mother printer PRT1 is specified as the printing destination printer and that a print job file is sent (downloaded) from the management server SV to the mother printer PRT1 specified as the printing destination printer.

The operator in the management center operates the client MCL to send (upload) the print job file to the management server SV and specifies the printer PRT1 as the printing destination printer. The print job file is then registered as a download file to be downloaded to the printer PRT1 as the printing destination printer.

Print job data included in the print job file downloaded to the printer PRT1 specified as the printing destination printer is distributed by the distributed printing control functions of the printer PRT1 from the printer PRT1 to the three distribution destination printers PRT1 to PRT3. The printers PRT1 to PRT3 respectively perform allocations of a print job corresponding to the received divisions of the print job data to implement distributed printing. Namely the three printers PRT1 to PRT3 are used as the printing execution printers.

A4. 1. Monitoring Print Status in Printing Destination Printer

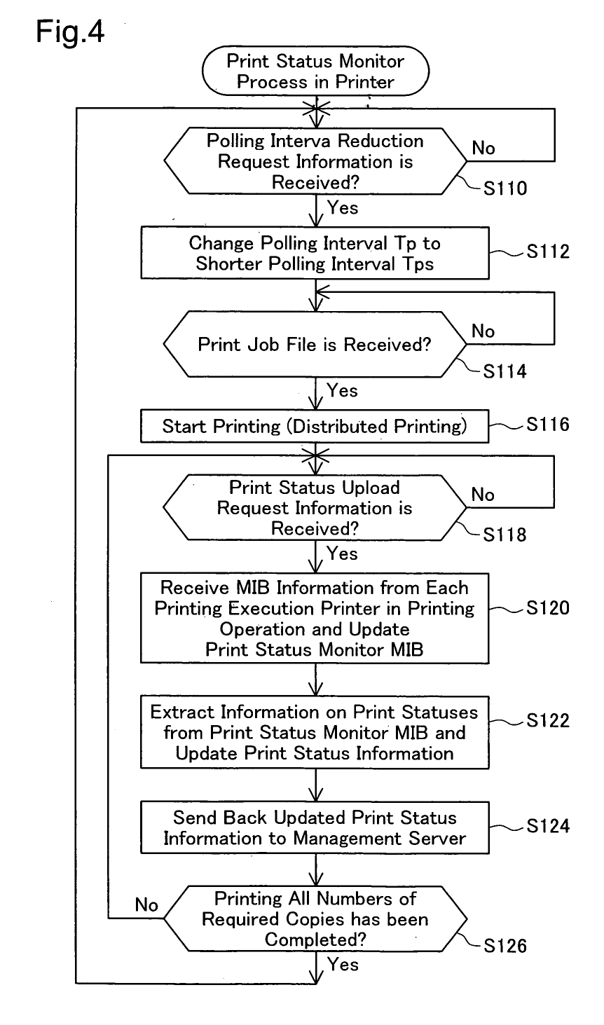

In the printer PRT1 (see FIG. 2) specified as the printing destination printer, the print status monitor control module 120 works to monitor the print status. FIG. 4 is a flowchart showing a print status monitor process executed in the printer PRT1 as the printing destination printer.

In the print status monitor process of FIG. 4, the print status monitor control module 120 first monitors reception of polling interval reduction request information (step S110). According to a concrete procedure, the print status monitor control module 120 controls the server access control module 114 to make polling to the management server SV at a polling interval Tp and repeatedly gain access to the management server SV. The polling interval Tp is generally set to a normal polling interval Tpn.

In response to reception of the polling interval reduction request information (step S110: Yes), the print status monitor control module 120 instructs the server access control module 114 to change the polling interval Tp from the normal polling interval Tpn to a shorter polling interval Tps (step S112). The normal polling interval Tpn is set equal to, for example, ‘30 seconds’, by taking into account the network traffic in communication with the management server SV. The shorter polling interval Tps is set equal to, for example, ‘5 seconds’, to dynamically monitor the momentarily changing print status. These setting values are stored in the control information storage field 130a and are read from the control information storage field 130a in the requirement for changing the polling interval Tp. The polling interval Tp is set in the timer 140.

The print status monitor control module 120 also monitors reception of a print job file (step S114). According to a concrete procedure, the print status monitor control module 120 controls the server access control module 114 to make polling to the management server SV at the shorter polling interval Tps set to the polling interval Tp and repeatedly gain access to the management server SV.

In response to reception of the print job file (step S114: Yes), printing starts according to the received print job file (step S116). A job index number allocated as a job ID of a print job specified by the received print job file is sent back to the management server SV as a response to the received print job file.

The print job file received in this embodiment is set for distributed printing. The distributed printing control module 118 then delivers divisions of the received print job file as distributed print job data with rewritten QT values to the respective distribution destination printers PRT1 to PRT3 to start distributed printing. When the received print job file represents a print job set for ordinary printing, the whole print job data is transferred to the printer controller 170 to start ordinary printing.

The procedure of this embodiment makes polling at the shorter polling interval Tps to receive a print job file, after reception of the polling interval reduction request information. The procedure may, however, receive a print job file before changing the polling interval Tp.

On a start of a print job according to the received print job file at step S116, the print status monitor control module 120 actually starts monitoring the print status as described below.

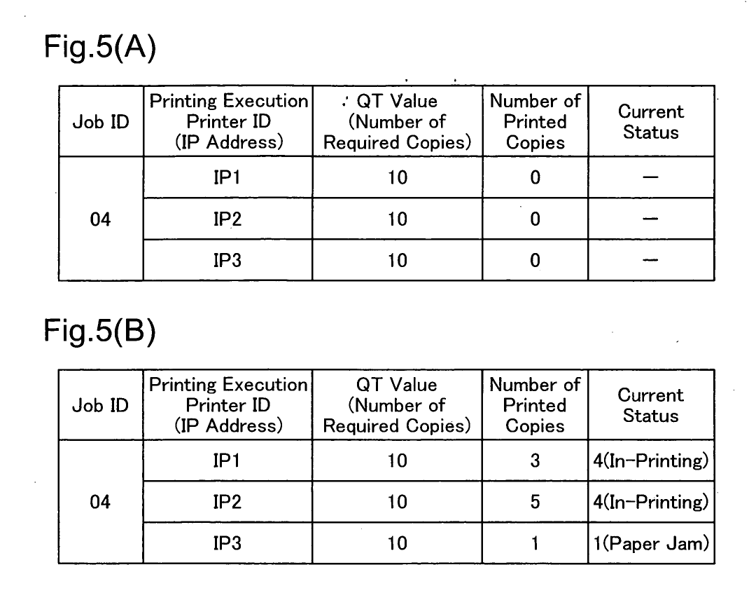

FIGS. 5(A) and 5(B) show print status information stored in the print status storage field 130e in the printer PRT1. On an actual start of monitoring the print status, tables for storage of the print status information are provided individually for print jobs specified by respective job IDs and are stored with their initial information settings into the print status storage field 130e as shown in FIG. 5(A). Each table includes IP addresses as ID information of the specified printing execution printers, QT values that are included in distributed print job data and represent the numbers of required copies to be printed by the respective printing execution printers, the numbers of printed copies, and current statuses of the respective printing execution printers. In the illustrated example of FIG. 5(A), the table provided for a print job with a job ID ‘04’ stores the initial information settings including IP addresses ‘IP1’ to ‘IP3’ of the three distribution destination printers PRT1 to PRT3 as the ID information of the specified printing execution printers, a QT value ‘10 copies’ as the numbers of required copies to be printed by the respective printing execution printers PRT1 to PRT3, and ‘0 copy’ as the numbers of printed copies completed by the printing execution printers PRT1 to PRT3. The current status column is vacant at the starting time.

On an actual start of monitoring the print status in the print status monitor process of FIG. 4, the print status monitor control module 120 monitors reception of print status upload request information (step S118). According to a concrete procedure, the print status monitor control module 120 controls the server access control module 114 to make polling to the management server SV at the shorter polling interval Tps and repeatedly gain access to the management server SV.

In response to reception of the print status upload request information (step S118: Yes), the print status monitor control module 120 receives MIB information from each printing execution printer in a printing operation and updates the print status monitor MIB stored in the MIB storage field 130f (step S120). According to a concrete procedure, the print status monitor control module 120 sends a preset command on the SNMP to each printing execution printer in a state other than the ‘end-of-printing’ state as the current status in the print status information stored in the print status storage field 130e. The print status monitor control module 120 receives MIB information stored in an MIB storage field set in a memory of a printer main body of the printing execution printer in response to the preset command and updates the print status monitor MIB stored in the MIB storage field 130f with the received MIB information.

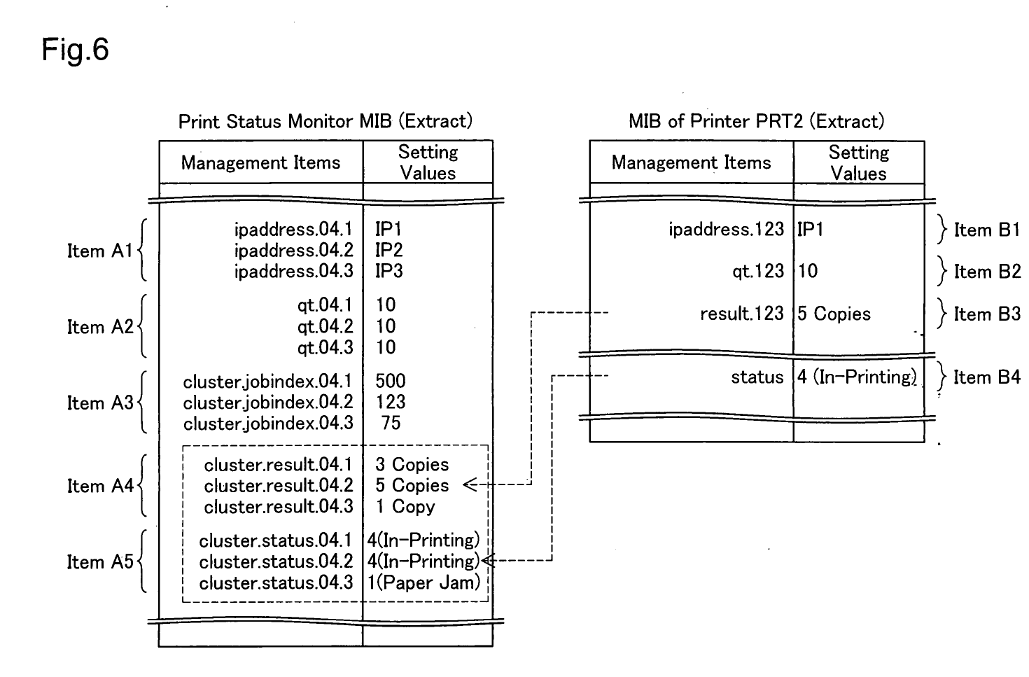

FIG. 6 shows a print status monitor MIB stored in the MIB storage field 130f in the printer PRT1 as the printing destination printer and an MIB stored in the memory of the printer main body of the specified distribution destination printer. An MIB of the printer PRT2 is shown in FIG. 6 as the MIB stored in the memory of the specified distribution destination printer.

The left half of FIG. 6 shows the print status monitor MIB, and the right half shows the MIB of the printer PRT2. For the simplicity of illustration, only some extracts are shown as the print status monitor MIB and the MIB of the printer PRT2 in FIG. 6.

In the print status monitor MIB and the MIB of the printer PRT2 shown in FIG. 6, the left column has management items and the right column has setting values (MIB values) in the respective management items. In the print status monitor MIB of FIG. 6, an item A1 shows the IP addresses of the respective distribution destination printers, an item A2 shows the QT values set in distributed print job data as divisions of print job data, an item A3 shows the job index numbers allocated to the distributed print job data delivered as the divisions of the print job data to the respective distribution destination printers, an item A4 shows the numbers of printed copies completed as processing results of the distributed print job data, and an item A5 shows the current statuses of the respective distribution destination printers. In the MIB of the printer PRT2 of FIG. 6, an item B1 shows the IP address of the sender of a received division of the print job data, an item B2 shows the QT value set in the received division of the print job data, an item B3 shows the number of printed copies by the printer PRT2, and an item B4 shows the current status of the printer PRT2.

In response to distribution of a print job to the respective distribution destination printers, the print status monitor control module 120 (see FIG. 2) adds the items A1 and A2 to the print status monitor MIB and sets the MIB values in the added items A1 and A2. In the illustrated example of FIG. 6, a print job file is sent from the management server SV to the printer PRT1, and the distributed printing control module 118 in the printer PRT1 sets the QT value ‘10’ in respective divisions of an original print job specified by the received print job file and delivers the divisions of the original print job as distributed print job data to the respective distribution destination printers PRT1 to PRT3. The distributed printing control module 118 allocates a job index number ‘04’ as job ID to the original print job and job index numbers ‘04.1’ to ‘04.3’ as job IDs to three divisions of the original print job as distributed print job data. The job index numbers of the distributed print job data are related to the job ID of the original print job. The print status monitor control module 120 adds the items A1 and A2 to the print status monitor MIB with regard to the distributed print job data with the allocated job index numbers and sets the IP addresses ‘IP1’ to ‘IP3’ of the distribution destination printers as the MIB values in the item A1 and the QT value ‘10’ as the MIB values in the item A2.

The printer PRT2 receives one division of the original print job as distributed print job data from the printer PRT1 and newly allocates a job index number to identify the distributed print job data. The printer controller of the printer PRT2 adds the items B1 to B3 to the MIB of the printer PRT2 and sets the MIB values in the respective added items B1 to B3. In the illustrated example of FIG. 6, the printer PRT2 newly allocates a job index number ‘123’ to the distributed print job data and sets the IP address ‘IP1’ of the printer PRT1 as the sender of the distributed print job data with the job index number ‘123’ as the MIB value in the item B1 and the QT value ‘10’ as the MIB value in the item B2. The MIB value in the item B3 is set to ‘0 copy’ as an initial value and is successively updated to increment as ‘1 copy’, ‘2 copies’, . . . , on completion of printing each copy. In the state of FIG. 6, printing ‘5 copies’ has been completed, and the MIB value in the item B3 is equal to ‘5 copies’.

Immediately after the distributed printing control module 118 delivers the respective divisions of the print job data to the specified distribution destination printers, the print status monitor control module 120 (see FIG. 2) sends a preset command on the SNMP to the respective distribution destination printers to obtain the latest job index numbers from the respective distribution destination printers. Each distribution destination printer sequentially allocates a job index number, which is an integral value successively incrementing by one, to each distributed print job data in the order of reception. The latest job index number obtained from each distribution destination printer immediately after the delivery of distributed print job data is accordingly identical with the job index number allocated to the distributed print job data in the distribution destination printer.

The print status monitor control module 120 sets the obtained latest job index number as the MIB value in the item A3 of the print status monitor MIB, in relation to the job index number allocated by the distributed printing control module 118. In the illustrated example of FIG. 6, when the printer PRT2 allocates the job index number ‘123’ to the received division of the print job data as the distributed print job data, the print status monitor control module 120 obtains the latest job index number ‘123’ and sets the obtained latest job index number ‘123’ as the MIB value in the item A3, in relation to the job index number ‘04.2’ allocated by the distributed printing control module 118.

A status number representing the current status of the printer PRT2, for example, ‘in printing’, ‘end of printing’, ‘paper jam’, or ‘out of toner’, is set as the MIB value in the item B4 in the MIB of the printer PRT2 shown in FIG. 6.

In the same manner as setting the item A3 in the print status monitor MIB, the print status monitor control module 120 sets the numbers of printed copies and the status numbers received from the respective printing execution printers as the MIB values in the items A4 and A5 in the print status monitor MIB, in relation to the job index numbers allocated by the distributed printing control module 118 (step S120).

After updating the print status monitor MIB stored in the MIB storage field 130f at step S120 in the print status monitor process of FIG. 4, the print status monitor control module 120 extracts information representing the print statuses of the respective printing execution printers from the updated print status monitor MIB and updates the print status information stored in the print status storage field 130e with the extracted information as shown in FIG. 5(B) (step S122). The information representing the print statuses of the respective printing execution printers includes, for example, the numbers of printed copies in the item A4 and the current statuses in the item A5 in the print status monitor MIB surrounded by the broken line in FIG. 6. In the illustrated example of FIG. 5(B), the number of printed copies and the current status of the printer PRT1 are updated to ‘3 copies’ and ‘in printing’, those of the printer PRT2 are updated to ‘5 copies’ and ‘in printing’, and those of the printer PRT3 are updated to ‘1 copy’ and ‘paper jam’. The print status monitor control module 120 then controls the server access control module 114 to send back (upload) the updated print status information to the management server SV as the response to the received print status upload request information (step S124). For reduction of the transmitted information volume, only relevant pieces of the updated print status information having any changes from the previous print status information are uploaded in relation to the ID information of the respective printing execution printers as the response to the management server SV. All pieces of the updated print status information in the print status storage field 130e including those without any change from the previous print status information may alternatively be uploaded to the management server SV as the response.

The print status monitor control module 120 subsequently specifies completion or non-completion of printing all the numbers of required copies (step S126). The procedure of such specification refers to the print status information stored in the print status storage field 130e and determines whether the current statuses of all the printing execution printers are ‘end-of-printing’. In the illustrated example, it is determined whether the current statuses of all the printers PRT1 to PRT3 specified as the printing execution printers are ‘end-of-printing’.

On non-completion of printing all the numbers of required copies, that is, when any of the printing execution printers has the current status other than ‘end-of-printing’ (step S126: No), the print status monitor process repeatedly executes the processing of steps S118 to S124.

On completion of printing all the numbers of required copies, that is, when all the printing execution printers have the current status ‘end-of-printing’ (step S126: Yes), on the other hand, the print status monitor process goes back to step S110. The print status monitor control module 120 waits until reception of the polling interval reduction request information at step S110, reception of another print job file at step S114, and reception of the print status upload request information at step S118.

A4.2. Monitoring Print Status in Management Server

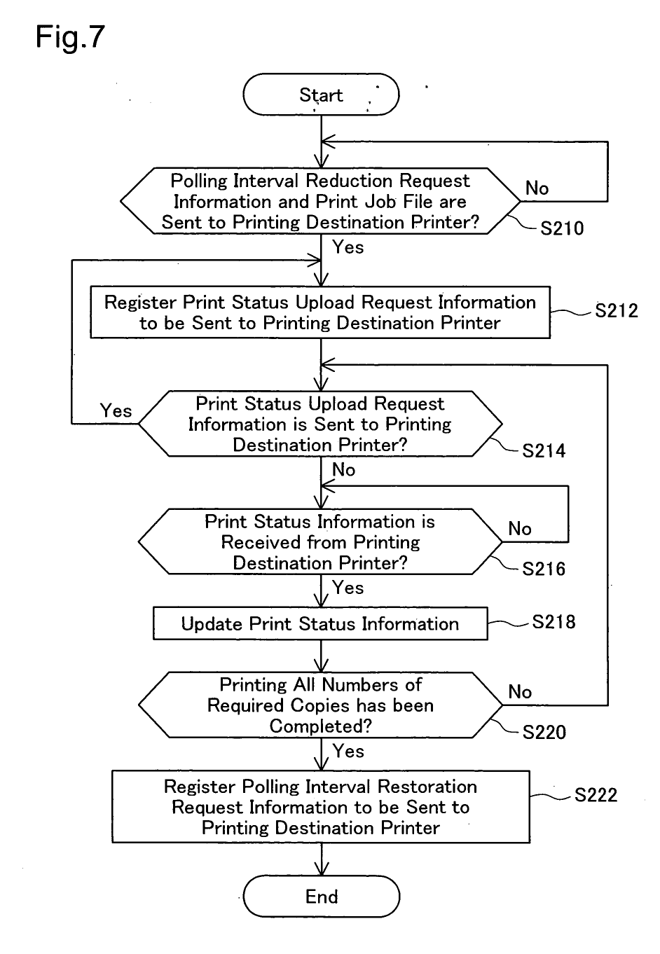

In the management server SV (see FIG. 3), the print job monitor module 218 works to monitor the print status. FIG. 7 is a flowchart showing a print status monitor process executed in the management server SV. The print job monitor module 218 starts the print status monitor process of FIG. 7 on registration of a print job file obtained by the print job registration module 216 as a download file to be sent to the mother printer PRT1 specified as the printing destination printer.

In the print status monitor process of FIG. 7, the print job monitor module 218 first monitors transmission of the polling interval reduction request information and the registered print job file to the mother printer PRT1 specified as the printing destination printer to receive the registered print job file (step S210). According to a concrete procedure, the print job monitor module 218 monitors transmission (download) of both the polling interval reduction request information and the registered print job file to the printer PRT1 via the device access control module 212 as the response to polling from the printer PRT1. On transmission of both the polling interval reduction request information and the registered print job file to the printer PRT1, the print job monitor module 218 starts monitoring the status of the print job (print status) executed according to the transmitted print job file.

The print job monitor module 218 controls the device access control module 212 to register the print status upload request information, which is to be sent to the printer PRT1 specified as the printing destination printer (step S212). The print status upload request information includes a job ID for identifying a print job. The job ID is sent back from the printer PRT1 as the response to transmission of the print job file and is set in the print status information stored in the print job monitoring result storage field 230e.

The print job monitor module 218 then monitors transmission of the print status upload request information to the printer PRT1 specified as the printing destination printer (step S214). According to a concrete procedure, the print job monitor module 218 determines whether the print status upload request information is sent to the printer PRT1 at the polling timing of the printer PRT1 corresponding to the shorter polling interval Tps. On transmission of the print status upload request information (step S214: Yes), the print status monitor process goes back to step S212 and repeats the registration of the print status upload request information at step S212 and the monitoring at step S214. The affirmative answer (transmission of the print status upload request information) is given at step S214 at every polling timing of the printer PRT1 corresponding to the shorter polling interval Tps. The negative answer (no transmission of the print status upload request information) is given at step S214 between the polling timings. The print job monitor module 218 waits until reception of the print status information sent back from the printer PRT1 as the response to the print status upload request information (step S216).

On reception of the print status information (step S216: Yes), the print job monitor module 218 updates the print status information stored in the print job monitoring result storage field 230e (step S218).

The print job monitor module 218 subsequently specifies completion or non-completion of printing all the numbers of required copies (step S220). The procedure of such specification refers to the print status information stored in the print job monitoring result storage field 230e and determines whether the current statuses of all the printing execution printers are ‘end-of-printing’. In the illustrated example, it is determined whether the current statuses of all the printers PRT1 to PRT3 specified as the printing execution printers are ‘end-of-printing’.

On non-completion of printing all the numbers of required copies, that is, when any of the printing execution printers has the current status other than ‘end-of-printing’ (step S220: No), the print status monitor process repeatedly executes the processing of steps S214 to S218.

On completion of printing all the numbers of required copies, that is, when all the printing execution printers have the current status ‘end-of-printing’ (step S220: Yes), on the other hand, the print job monitor module 218 controls the device access control module 212 to register polling interval restoration request information, which is to be sent to the printer PRT1 as the printing destination printer (step S222) and exits from the print status monitor process of FIG. 7.

The registered polling interval restoration request information is sent (downloaded) to the printer PRT1 at the polling timing of the printer PRT1. The printer PRT1 restores the polling interval Tp from the shorter polling interval Tps to the normal polling interval Tpn and is set in the general device monitoring state.

A4.3. Display of Print Status

The print status information is obtained as the monitoring result of the print status by the print status monitor control module 120 included in the printer PRT1 (see FIG. 2) specified as the printing destination printer and by the print job monitor module 218 included in the management server SV (see FIG. 3) specified as the print request sender. The monitoring result presentation module 220 of the management server SV displays the obtained print status information in the form of a print status display window on the browser executed by the client MCL or in the form of a print status display window on the monitor DP of the management server SV.

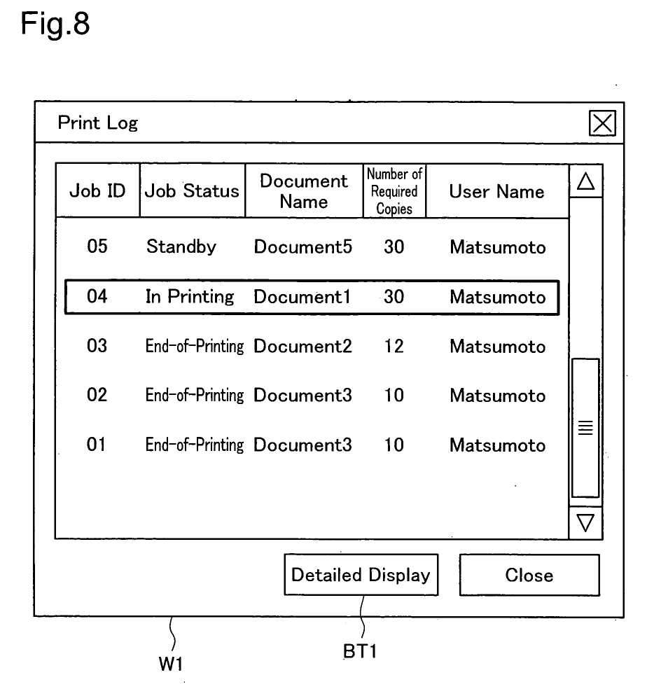

FIG. 8 shows a print status display window W1 displayed by the monitoring result presentation module 220 of the management server SV. The print status display window W1 shown in FIG. 8 includes columns of job ID, job status, document name, number of required copies, and user name. The print status display window W1 also has a ‘Detailed Display’ button BT1 and a ‘Close’ button.

The job status column is based on the print status information received from the printer PRT1 or the printing destination printer. For example, the print status information stored in the print job monitoring result storage field 230e with regard to a print job with a job ID ‘04’ is updated as shown in FIG. 5(B). The monitoring result presentation module 220 refers to the print status information including the current statuses, specifies non-completion of the print job with the job ID ‘04’ by the specified distribution destination printers (printing execution printers), and displays the job status ‘in printing’ in the job status column of the print job with the job ID ‘04’ in print status display window W1. With regard to print jobs with job IDs ‘01’to ‘03’, the current statuses of all the distribution destination printers are ‘end-of-printing’ in the print status information stored in the print job monitoring result storage field 230e. The job status ‘end-of-printing’ is accordingly displayed in the job status column of the print jobs with the job IDs ‘01’ to ‘03’ in the print status display window W1. With regard to a print job with a job ID ‘05’, there is no print status information in the print job monitoring result storage field 230e. The monitoring result presentation module 220 accordingly specifies no distribution of the print job with the job ID ‘05’ and displays the job status ‘standby’ in the job status column of the print job with the job ID ‘05’.

When the operator operates the mouse or the keyboard to specify a job ID and activate the ‘Detailed Display’ button BT1 on the print status display window W1, the monitoring result presentation module 220 displays a detailed print status display window W2, based on the print status information read from the print job monitoring result storage field 230e.

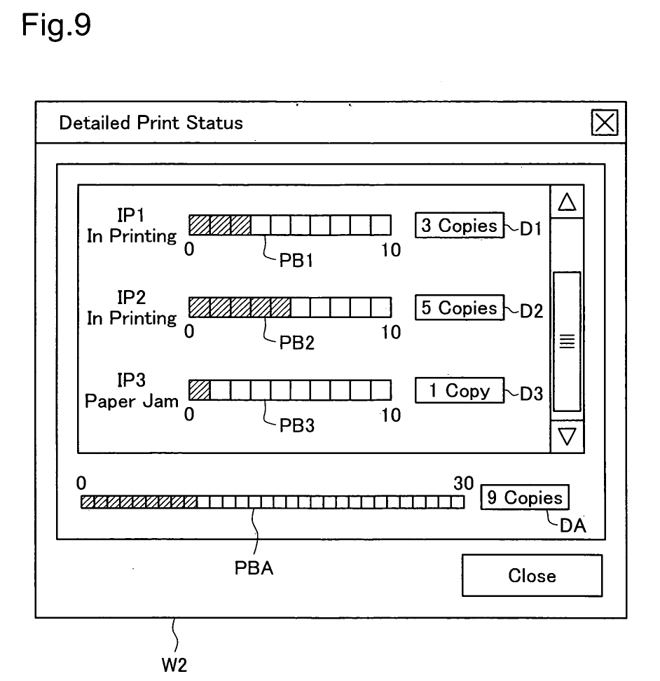

FIG. 9 shows the detailed print status display window W2 displayed by the monitoring result presentation module 220. The detailed print status display window W2 of FIG. 9 is opened in response to the operator's specification of the job ID ‘04’ and activation of the ‘Detailed Display’ button BT1 on the print status display window W1 shown in FIG. 8. The detailed print status display window W2 includes the IP addresses ‘IP1’ to ‘IP3’ of the printers PRT1 to PRT3 specified as the distribution destination printers, job statuses, for example, ‘in printing’, ‘end of printing’, ‘paper jam’, or ‘out of toner’, in the respective printers PRT1 to PRT3, progress bars PB1 to PB3 representing the current statues of distributed print job data delivered as divisions of the print job with the specified job ID ‘04’ to the respective printers PRT1 to PRT3, and printed copy number display boxes D1 to D3 showing the numbers of printed copies by the respective printers PRT1 to PRT3. The detailed print status display window W2 also includes a progress bar PBA representing the current status of the whole print job with the job ID ‘04’ and a total printed copy number display box DA showing the total number of printed copies.

Each of the progress bars PB1 to PB3 shows the number of printed copies in a dark color relative to the number of required copies to be printed by each of the distribution destination printers. Each of the progress bars PB1 to PB3 has a scale in units of copies; the left-most point and the right-most point on the scale respectively show ‘0 copy’ and the ‘number of required copies’. When the QT value ‘10’ is set in the distributed print job data delivered to the respective printers PRT1 to PRT3, the values ‘0’ and ‘10’ are displayed respectively at the left-most points and the right-most points below the scales of the progress bars PB1 to PB3, based on the ‘QT values’ set in the distributed print job data stored as the print status information in the print job monitoring result storage field 230e.

The monitoring result presentation module 220 specifies and displays dark color areas on the progress bars PB1 to PB3 and the numbers of printed copies in the printed copy number display boxes D1 to D3, based on the ‘numbers of printed copies’ by the respective distribution destination printers stored as the print status information in the print job monitoring result storage field 230e.

The progress bar PBA shows the total number of printed copies in a dark color relative to the total number of required copies to be printed as the whole print job with the job ID ‘04’. Like the progress bars PB1 to PB3, the progress bar PBA has a scale in units of copies; the left-most point and the right-most point on the scale respectively show ‘0 copy’ and the ‘total number of required copies’. When the QT value ‘10’ is set in the distributed print job data delivered to the respective printers PRT1 to PRT3, the values ‘0’ and ‘30’ as the sum of the QT values are displayed respectively at the left-most point and the right-most point above the scale of the progress bar PBA, based on the ‘QT values’ set in the distributed print job data stored as the print status information in the print job monitoring result storage field 230e.

The monitoring result presentation module 220 refers to the ‘numbers of printed copies’ by the respective distribution destination printers stored as the print status information in the print job monitoring result storage field 230e and sums up the numbers of printed copies to compute the total number of printed copies (9 copies). The monitoring result presentation module 220 displays the computed total number of printed copies (9 copies) as a dark color area on the progress bar PBA and in the total printed copy number display box DA.

The print jobs with the job IDs ‘01’ to ‘03’ have been completed by all the distribution destination printers. When the operator specifies one of the job IDs ‘01’ to ‘03’ and activates the ‘Detailed Display’ button BT1 on the print status display window W1 of FIG. 8, the whole scales are displayed in the dark color on the progress bar PBA and all the progress bars corresponding to the distribution destination printers on the detailed print status display window W2 with regard to the specified job ID. The total printed copy number display box DA shows, for example, ‘50 copies’ as a QT value ‘50’ set in the print job data sent from the client MCL to the printer PRT1. When the operator specifies the job ID ‘05’ on the print status display window W1 of FIG. 8, the ‘Detailed Display’ button BT1 for opening the detailed print status display window W2 is grayed out to be inactivated.

A5. Effects of Embodiment

In the device management system 1000 of the embodiment described above, the management server SV as the print request sender sends a print job file, which specifies a print job to be executed, over the firewall FW to the printer PRT1 as the printing destination printer. Prior to a start of monitoring the status of the print job, the management server SV sends the polling interval reduction request information at the polling timing of the printer PRT1 to change the polling interval of the printer PRT1 from the normal polling interval to the shorter polling interval.

The management server SV sends the print status upload request information, as a request for sending (uploading) the print status information representing the status of the print job (print status), to the printer PRT1 at every polling timing of the printer PRT1 corresponding to the shorter polling interval. In response to the print status upload request, the printer PRT1 obtains the print status information of the print job and sends back (uploads) the obtained print status information to the management server SV. The printer PRT1 works as the distribution source printer and distributes the print job data to the three printers PRT1 to PRT3 specified as the distribution destination printers for distributed printing. The printer PRT1 as the printing destination printer thus collectively obtains the print status information of the three printers PRT1 to PRT3 as the printing execution printers.

In the device management system 1000 of the embodiment, the management server SV as the print request sender changes the polling interval of the printer PRT1 as the printing destination printer to the shorter polling interval to monitor the status of the print job. The print status information of the print job is uploaded to the management server SV at every polling of the printer PRT1 corresponding to the shorter polling interval. This arrangement ensures sufficiently monitoring of the momentarily changing print status.

The polling interval of the printer PRT1 as the printing destination printer is changed to the shorter polling interval when the management server SV monitors the print status. The normal polling interval otherwise set to the polling interval of the printer PRT1 is determined by taking into account the network traffic. This arrangement enables effective monitoring of the momentarily changing print status, while reducing the potential for heavy network traffic.

B. Modifications

The embodiment discussed above is to be considered in all aspects as illustrative and not restrictive. There may be many modifications, changes, and alterations without departing from the scope or spirit of the main characteristics of the present invention. Some examples of possible modification are given below.

B1. Modified Example 1

The print status monitor process of the embodiment is applied to distributed printing where the printer PRT1 is specified as the printing destination printer and as the distribution source printer and the three printers PRT1 to PRT3 are specified as the distribution destination printers and as the printing execution printers. The printer PRT1 specified as the printing destination printer collectively obtains the print statues of the printers PRT1 to PRT3 as the printing execution printers and sends (uploads) the obtained print statuses as the print status information in response to a print status upload request from the management server SV. This application is, however, not restrictive. The print status monitoring technique of the invention is also applicable to ordinary printing with only the printer PRT1 specified as the printing destination printer and as the printing execution printer. The printer PRT1 as the printing destination printer sends (uploads) the print status information of the printer PRT1 as the printing execution printer in response to a print status upload request from the management server SV. In the latter application, the print status monitor MIB stored in the MIB storage field 130f of the printer PRT1 as the printing destination printer stores the MIB information of only the printer PRT1 as the printing execution printer.

B2. Modified Example 2

In the device management system 1000 of the embodiment described above, only the printer PRT1 has the built-in print status monitor control apparatus of the invention. All or any part of multiple printers on a LAN may have the built-in print status monitor control apparatus of the invention.

Finally the present application claims the priority based on Japanese Patent Application No. 2005-040051 filed on Feb. 17, 2005, which is herein incorporated by reference.

What is claimed is:

1. A print status monitor control apparatus that is built in at least one specified printer among multiple printers on a certain network to monitor status of a print job sent from a server, which is connected to the certain network via a firewall, and to send a monitoring result to the server,
the print status monitor control apparatus comprising:
a server access control module that makes polling to the server at a preset polling interval and establishes communication with the server; and
a print status monitor control module that monitors the status of the print job,
in response to reception of a polling interval reduction request from the sever, the server access control module changing the polling interval to a shorter polling interval, which is shorter than a preset normal polling interval,
when the server access control module makes polling to the server at the shorter polling interval and receives a print status transmission request from the server, the print status monitor control module obtaining print status information representing the status of the print job and controlling the server access control module to send the obtained print status information to the server.

2. A print status monitor control apparatus in accordance with claim 1, the print status monitor control apparatus further comprising:
a distributed printing control module that distributes the print job to at least one distribution destination printer specified among the multiple printers,
wherein in the case of distribution of the print job to the specified distribution destination printer, the print status monitor control module obtains information representing a status of each division of the distributed print job from the specified distribution destination printer, as the print status information.

3. A print status monitor control apparatus in accordance with claim 1, wherein the print status monitor control module sends only a piece of information having any change between polling timings of the shorter polling interval to the server as the print status information.

4. A print status monitor control apparatus in accordance with claim 2, wherein the print status monitor control module sends only a piece of information having any change between polling timings of the shorter polling interval to the server as the print status information.

5. A printer connected to a certain network, the printer having a print status monitor control apparatus in accordance with claim 1.

6. A printer connected to a certain network, the printer having a print status monitor control apparatus in accordance with claim 2.

7. A server that is connected to a certain network via a firewall and receives print status information representing status of a print job, which is sent to at least one specified printer among multiple printers on the certain network,
the server comprising:
a device access control module that establishes communication with the specified printer, in response to polling made by the specified printer at a preset polling interval; and
a print job monitor module that causes the specified printer to monitor the status of the print job,
the print job monitor module controlling the device access control module to send a polling interval reduction request to the specified printer, in response to polling made by the specified printer at a normal polling interval set to the polling interval, and causing the specified printer to change the polling interval of the specified printer to a shorter polling interval, which is shorter than the normal polling interval,
the print job monitor module controlling the device access control module to send a print status transmission request to the specified printer, in response to polling made by the specified printer at the shorter polling interval, and controlling the device access control module to receive and obtain the print status information sent back from the specified printer in response to the print status transmission request.

8. A print status monitor system where a server connected to a certain network via a firewall monitors status of a print job, which is sent from the server to at least one specified printer among multiple printers on the certain network,
the server sending a polling interval reduction request to the specified printer, in response to polling made by the specified printer at a normal polling interval set to a polling interval,
the specified printer changing the polling interval to a shorter polling interval, which is shorter than the normal polling interval, in response to reception of the polling interval reduction request from the server and making polling to the server at the shorter polling interval,
the server sending a print status transmission request to the specified printer in response to the polling made by the specified printer at the shorter polling interval,
the specified printer receiving the print status transmission request sent from the server in response to the polling made to the server at the shorter polling interval, obtaining print status information representing the status of the print job, and sending the obtained print status information to the server,
the server receiving and acquiring the print status information sent from the specified printer in response to the print status transmission request.

9. A control method of a print status monitor control apparatus, the print status monitor control apparatus being built in at least one specified printer among multiple printers on a certain network to monitor status of a print job sent from a server, which is connected to the certain network via a firewall, and to send a monitoring result to the server,
the control method comprising the steps of
(a) in response to reception of a polling interval reduction request from the sever, changing a polling interval to a shorter polling interval, which is shorter than a preset normal polling interval;
(b) making polling to the server at the shorter polling interval, receiving a print status transmission request from the sever in response to the polling, and obtaining print status information representing the status of the print job; and
(c) sending the obtained print status information to the server.

10. A control method of a server, the server being connected to a certain network via a firewall and receiving print status information representing status of a print job, which is sent to at least one specified printer among multiple printers on the certain network,
the control method comprising the steps of
(a) sending a polling interval reduction request to the specified printer, in response to polling made by the specified printer at a normal polling interval set to a polling interval, and causing the specified printer to change the polling interval of the specified printer to a shorter polling interval, which is shorter than the normal polling interval;
(b) sending a print status transmission request to the specified printer, in response to polling made by the specified printer at the shorter polling interval; and
(c) receiving and obtaining the print status information sent back from the specified printer in response to the print status transmission request.

11. A control method of a print status monitor system where a server connected to a certain network via a firewall monitors status of a print job, which is sent from the server to at least one specified printer among multiple printers on the certain network,
the control method comprising the steps of:
(a) causing the server to send a polling interval reduction request to the specified printer, in response to polling made by the specified printer at a normal polling interval set to a polling interval;
(b) causing the specified printer to change the polling interval to a shorter polling interval, which is shorter than the normal polling interval, in response to reception of the polling interval reduction request from the server and to make polling to the server at the shorter polling interval;
(c) causing the server to send a print status transmission request to the specified printer in response to the polling made by the specified printer at the shorter polling interval;
(d) causing the specified printer to receive the print status transmission request sent from the server in response to the polling made to the server at the shorter polling interval, to obtain print status information representing the status of the print job, and to send the obtained print status information to the server; and
(e) causing the server to receive and acquire the print status information sent from the specified printer in response to the print status transmission request.

12. A computer program product that is used to control a print status monitor control apparatus, the print status monitor control apparatus being built in at least one specified printer among multiple printers on a certain network to monitor status of a print job sent from a server, which is connected to the certain network via a firewall, and to send a monitoring result to the server,
the computer program product comprising:
a first program code of, in response to reception of a polling interval reduction request from the sever, changing a polling interval to a shorter polling interval, which is shorter than a preset normal polling interval;
a second program code of making polling to the server at the shorter polling interval, receiving a print status transmission request from the sever in response to the polling, and obtaining print status information representing the status of the print job;
a third program code of sending the obtained print status information to the server; and
a computer readable medium that stores the first to the third program codes.

13. A computer program product that is used to control a server, the server being connected to a certain network via a firewall and receiving print status information representing status of a print job, which is sent to at least one specified printer among multiple printers on the certain network,
the computer program product comprising:
a first program code of sending a polling interval reduction request to the specified printer, in response to polling made by the specified printer at a normal polling interval set to a polling interval, and causing the specified printer to change the polling interval of the specified printer to a shorter polling interval, which is shorter than the normal polling interval;
a second program code of sending a print status transmission request to the specified printer, in response to polling made by the specified printer at the shorter polling interval;
a third program code of receiving and obtaining the print status information sent back from the specified printer in response to the print status transmission request; and
a computer readable medium that stores the first to the third program codes.
